(19) United States
(12) Patent Application Publication
(10) Pub. No.: US 2013/0205832 A1
(43) Pub. Date: Aug. 15, 2013

(54) METHOD FOR PRODUCING DOPED QUARTZ GLASS

(71) Applicant: ASAHI GLASS COMPANY, LIMITED, (US)

(72) Inventors: Junko MIYASAKA, Tokyo (JP); Tomonori Ogawa, Tokyo (JP)

(73) Assignee: ASAHI GLASS COMPANY, LIMITED, Chiyoda-ku (JP)

(21) Appl. No.: 13/761,657

(22) Filed: Feb. 7, 2013

(30) Foreign Application Priority Data
Feb. 9, 2012 (JP) 2012-025971
Feb. 5, 2013 (JP) 2013-020048

(51) Int. Cl. C03B 20/00

(52) U.S. Cl. CPC C03B 20/00
USPC 65/21.1; 65/33.4

(57) ABSTRACT

The present invention relates to a method for producing a doped quartz glass, containing: a raw material gas-forming step of vaporizing a liquid raw material containing a silicon compound and a sublimable organic metal compound to form a raw material gas, and a glass fine particle-forming step of feeding the raw material gas to oxyhydrogen flame and reacting the gas in the flame to form a glass fine particle.

### TECHNICAL FIELD

The present invention relates to a method for producing a quartz glass doped with a metal element such as a rare earth element.

### BACKGROUND ART

As methods for producing a quartz glass doped with a metal element such as a rare earth element, there are known (1) a method of feeding a silicon compound as a glass-forming material to oxyhydrogen flame, depositing a silica glass fine particle formed in the flame to form a porous glass base material, impregnating the porous glass base material with a solution of a rare earth element compound, and sintering the impregnated porous glass base material at a high temperature to achieve vitrification (for example, see Patent Document 1), (2) a method of feeding a glass-forming raw material gas containing a halogen and a vaporized substance of a sublimable organic rare earth element compound to a reaction system (for example, see Patent Documents 2 to 4), and the like.

However, it is difficult to distribute a dopant (rare earth element oxide) homogeneously in the glass by any of the above methods. Namely, the method (1) of impregnating the porous glass base material with a solution of a rare earth element compound has advantages that a doping amount can be controlled by changing concentration of the solution and the method can be also applied to a compound having a low vapor pressure but it is difficult to impregnate the porous glass base material with the solution homogeneously and thus concentration distribution of the dopant is generated.

On the other hand, in the method (2), in the case where the glass-forming raw material gas is a chloride, there is a concern that the sublimable organic rare earth element compound reacts with the glass-forming raw material gas to form a solid matter and it blocks pipes or the like. Even when such a reaction does not occur, the organic rare earth element compound is decomposed upon heating for a long period of time and hence the vapor pressure varies. Moreover, since the sublimable organic rare earth element compound is solid, variation in surface area is prone to occur during continuous vaporization. Therefore, it is difficult to feed the vaporized substance stably and hence it is difficult to form a homogeneous glass.

[Patent Document 1] JP-B-58-3980

[Patent Document 2] JP-B-3-72575

[Patent Document 3] JP-A-4-300218

[Patent Document 4] JP-A-5-330831

### SUMMARY OF THE INVENTION

An object of the present invention is to provide a method capable of easily and stably producing a doped quartz glass in which a metal element such as a rare earth element is homogeneously distributed at a desired concentration.

The present invention provides a method for producing a doped quartz glass, the method contains:

a raw material gas-forming step of vaporizing a liquid raw material containing a silicon compound and a sublimable organic metal compound to form a raw material gas and

a glass fine particle-forming step of feeding the raw material gas to oxyhydrogen flame and reacting the gas in the flame to form a glass fine particle.

One embodiment of the present invention is a method for producing a doped quartz glass, the method contains:

a raw material gas-forming step of vaporizing a liquid raw material containing a silicon compound and a sublimable organic metal compound to form a raw material gas,

a glass fine particle-forming step of feeding the raw material gas to oxyhydrogen flame and reacting the gas in the flame to form a glass fine particle,

a base material-forming step of depositing the glass fine particle on a substrate to form a porous glass base material, and

a vitrification step of sintering the porous glass base material to achieve transparent vitrification.

Another embodiment of the present invention is a method for producing a doped quartz glass, the method contains:

a raw material gas-forming step of vaporizing a liquid raw material containing a silicon compound and a sublimable organic metal compound to form a raw material gas,

a glass fine particle-forming step of feeding the raw material gas to oxyhydrogen flame and reacting the gas in the flame to form a glass fine particle, and

a vitrification step of depositing the glass fine particle on a substrate and melting the particle simultaneously with deposition to achieve vitrification.

In the present invention, it is preferred that the silicon compound contains no halogen.

Further, the silicon compound is preferably a liquid silicon compound which is in the form of a liquid at at least one temperature in a temperature range of from 10° C. to 150° C. In this case, the sublimable organic metal compound is preferably contained in the liquid raw material in a state dissolved or dispersed in the liquid silicon compound or a mixture containing the liquid silicon compound and a solvent. Further, the liquid raw material is preferably obtained by dissolving or dispersing the sublimable organic metal compound in at least a part of the liquid silicon compound and then optionally mixing the resulting solution or dispersion with the liquid silicon compound, or obtained by dissolving or dispersing the sublimable organic metal compound in a solvent and then mixing the resulting solution or dispersion with the liquid silicon compound. The solvent is preferably at least one selected from the group consisting of ethers and hydrocarbons.

In the present invention, the silicon compound is preferably at least one selected from the group consisting of hexamethyldisiloxane, hexamethylcyclotrisiloxane, octamethylcyclotetrasiloxane, decamethylcyclopentasiloxane, methyltrimethoxysilane, methyltriethoxysilane, tetramethoxysilane, and tetraethoxysilane. The sublimable organic metal compound is preferably a β-diketone complex and is preferably an organic rare earth element compound. Further, in the present invention, it is preferred that the liquid raw material contains no halide.

According to the method for producing a doped quartz glass of the present invention, since a silicon compound as a glass-forming material and a sublimable organic metal compound can be fed in stable amounts, a doped quartz glass in which the metal element is homogeneously distributed at a desired concentration can be easily and stably produced.

### BRIEF DESCRIPTION OF THE DRAWINGS

FIG. 1 is a drawing schematically showing a principal constitution of an apparatus for use in the production of a doped quartz glass of one embodiment of the present invention.

### DESCRIPTION OF REFERENCE NUMERALS AND SIGNS

10 Vaporizer

12 First liquid raw material pipe

14 Second liquid raw material pipe

16 Oxyhydrogen flame burner

17 Atomizer nozzle

18 Raw material gas pipe

19 Carrier gas inlet

### DETAILED DESCRIPTION OF THE INVENTION

The following will describe embodiments of the present invention.

The method for producing a doped quartz glass of the present invention contains a raw material gas-forming step of vaporizing a liquid raw material containing a silicon compound and a sublimable organic metal compound to form a raw material gas and a glass fine particle-forming step of feeding the raw material gas to oxyhydrogen flame and reacting the gas in the flame to form a glass fine particle.

The production method of the present invention includes a method of depositing and growing the glass fine particle (soot), which has been obtained in the above glass fine particle-forming step, on a substrate by a soot process to obtain a porous glass base material, subsequently heating the obtained porous glass base material to the densification temperature or higher under reduced pressure or in a helium atmosphere, and further heating it to a transparent vitrification temperature or higher to obtain a transparent glass. The soot process includes an MCVD process, an OVD process, a VAD process, and the like depending on the method of preparing the porous glass base material.

Moreover, the production method of the present invention includes a method of depositing the glass fine particle, which has been obtained in the above glass fine particle-forming step, on a substrate, for example, on a fireproof container or the like and melting it simultaneously with deposition to obtain a transparent glass (direct method).

The following will describe the embodiments of the present invention, which contain a step of forming the porous glass base material by the soot process. The following description will be made referring to the drawing but the drawing is provided for the sake of illustration and the present invention should not be construed as being limited to the drawing.

### Liquid Raw Material

In the present embodiment, a silicon compound and a sublimable organic metal compound are used as glass-forming materials for producing a doped quartz glass.

As the silicon compound, a chloride such as silicon tetrachloride (SiCl₄) may be used but there is a concern that such a chloride promotes a decomposition reaction of the sublimable organic metal compound as a dopant material and generates a concentration distribution of the dopant in the obtained glass, so that it is preferred not to use the chloride. Accordingly, it is preferred to use a silicon compound containing no halogen, particularly preferred to use an organic silicon compound containing no halogen.

Further, it is preferred to use a silicon compound that is in the form of a liquid at at least one temperature in a temperature range of from 10° C. to 150° C. When the silicon compound is a liquid silicon compound that is in the form of a liquid at at least one temperature in a temperature range of from 10° C. to 150° C., the raw material containing the silicon compound can be supplied in a liquid form stably without any control of temperature of a raw material tank or pipes or with only a simple temperature-controlling system. The silicon compound is more preferably in the form of a liquid at at least one temperature in a temperature range of from 15° C. to 100° C., further preferably in the form of a liquid at at least one temperature in a temperature range of from 20° C. to 50° C. It is most preferred that the silicon compound is in the form of a liquid at room temperature, that is, in a temperature range of from 20° C. to 30° C. In the present Description, a simply mentioned “liquid silicon compound” means a silicon compound that is in the form of a liquid at at least one temperature in a temperature range of from 10° C. to 150° C. and is in the form of a liquid at the time of being used, unless otherwise stated.

In the present invention, it is further preferred to use a liquid silicon compound containing no halogen.

Specific examples of the liquid silicon compound containing no halogen include organic silicon compounds, for example, polymethylsiloxanes such as hexamethyldisiloxane (HMDS), hexamethylcyclotrisiloxane (HMCTS), octamethylcyclotetrasiloxane (OMCTS), and decamethylcyclopentasiloxane (DMCPS); monosilyl compounds such as methyltrimethoxysilane (MTMS), methyltriethoxysilane (MTES), tetramethoxysilane (TMOS), and tetraethoxysilane (TEOS); and the like. Of these, from the standpoint of chemical stability of the organic metal compounds after mixing, OMCTS and TEOS are preferred. One of these silicon compounds may be used singly or two or more thereof may be used as a mixture.

The sublimable organic metal compound means a compound in which a metal atom is directly bonded to a carbon atom or a compound such as a metal salt of an organic acid or an alkoxide of a metal in which a counter atom directly bonding to the metal atom is oxygen, and which is a sublimable compound. A β-diketone complex or the like is preferred.

As the sublimable organic metal compound, use can be made of, for example, a β-diketone complex of a rare earth element such as cerium (Ce), yttrium (Y), neodymium (Nd), or erbium (Er); a β-diketone complex of another metal such as titanium (Ti), copper (Cu), strontium (Sr), or iridium (Ir); or the like.

The β-diketone complex of a metal element is obtained by, for example, reacting a chloride of the metal element with a β-diketone compound. Examples of the β-diketone compound constituting the ligand include 2,2,6,6-tetramethyl-3,5-heptanedione (thd), 1,1,1-trifluoro-2,4-pentanedione (tfa), 1,1,1,5,5,5-hexafluoro-2,4-pentanedione (hfa), 6,6,7,7,8,8,8-heptafluoro-2,2-dimethyl-3,5-octanedione (fod), 2,2,7-trimethyl-3,5-octanedione (tod), 1,1,1,5,5,6,6,7,7,7-decafluoro-2,4-heptanedione (dfhd), 1,1,1-trifluoro-6-methyl-2,4-heptanedione (tfmhd), and the like. Of these, from the standpoints of thermal stability and vapor pressure, 2,2,6,6-tetramethyl-3,5-heptanedione (thd) is preferred. Moreover, a compound where a part of ligands are substituted with alkoxy group(s) can be also employed.

Specific examples of the sublimable organic metal compound include organic metal compounds of β-diketone complexes and the like, such as bis(dipivaloylmethanato)-di-(2,2-dimethyl-1-propoxy)titanium, tris(acetylacetonato)iridium, tris(2,4-pentanedionato)iridium, bis(dipivaloylmethanato)strontium, and bis(6-ethyl-2,2-dimethyl-3,5-octanedionato)copper; organic rare earth element compounds, e.g., β-diketone complexes of rare earth elements, such as tetrakis(dipivaloylmethanato)cerium [Ce(thd)₄]; and the like. One of these sublimable organic metal compounds may be used singly or two or more thereof may be used as a mixture.

The sublimable organic metal compound is preferably contained in the liquid raw material in a state dissolved or dispersed in the liquid silicon compound or a mixture comprising the liquid silicon compound and a solvent.

The liquid raw material is preferably obtained by dissolving or dispersing the sublimable organic metal compound in at least a part of the liquid silicon compound and then optionally mixing the resulting solution or dispersion with the liquid silicon compound, or obtained by dissolving or dispersing the sublimable organic metal compound in a solvent and then mixing the resulting solution or dispersion with the liquid silicon compound.

The solvent to be used for this purpose is preferably one that does not react with the liquid silicon compound. Moreover, in order to prevent the deposition of the organic metal compound due to the vaporization of the solvent alone, the solvent preferably has a boiling point near to the temperature at which the liquid raw material supplied to a vaporizer is vaporized, that is, the set temperature inside the vaporizer or the temperature of the carrier gas supplied to the vaporizer. From this standpoint, an organic solvent having a boiling point in the range of 40° C. to 250° C. is preferred as the solvent.

Specific examples of the organic solvent satisfying such requirements include ethers such as propyl ether, methyl butyl ether, ethyl propyl ether, ethyl butyl ether, trimethylene oxide, tetrahydrofuran, and tetrahydropyran; alcohols such as methyl alcohol, ethyl alcohol, propyl alcohol, and butyl alcohol; ketones such as acetone, ethyl methyl ketone, iso-propyl methyl ketone, and iso-butyl methyl ketone; amines such as propylamine, butylamine, diethylamine, dipropylamine, and triethylamine; esters such as ethyl acetate, propyl acetate, and butyl acetate; hydrocarbons such as hexane, heptane and octane; and the like. Of these, from the standpoint of chemical stability of the organic metal compound, ethers and hydrocarbons are preferred. One of these solvents may be used singly or two or more thereof may be used as a mixture.

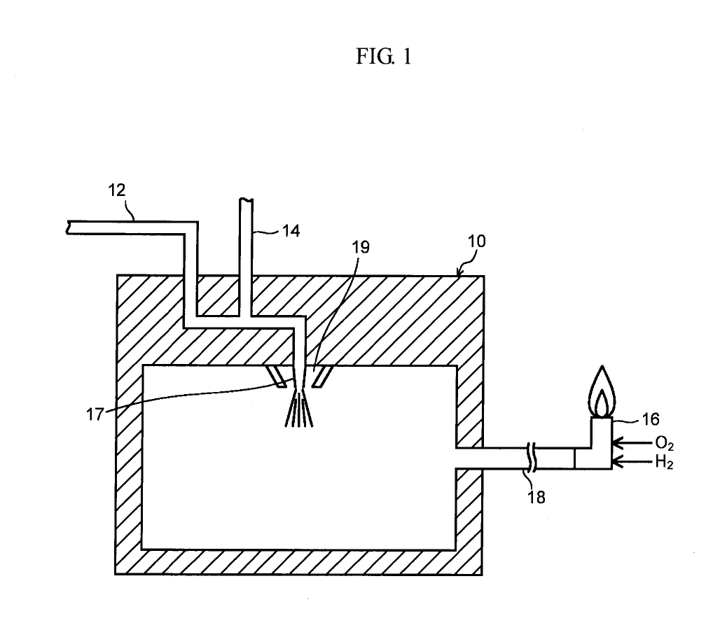

The following will describe a principal constitution of a doped quartz glass production apparatus for use in the method for producing a doped quartz glass of one embodiment of the present invention, with referring to FIG. 1.

As shown in FIG. 1, the apparatus is equipped with a vaporizer 10 that vaporizes a liquid raw material to form a raw material gas, a first liquid raw material pipe 12 connected to an upper part of the vaporizer 10 to feed liquid raw materials to the vaporizer 10, and a second liquid raw material pipe 14 branching from the halfway position of the first liquid raw material pipe 12. Namely, a liquid raw material transferred through the first liquid raw material pipe 12 and a liquid raw material transferred through the second liquid raw material pipe 14 are mixed in the pipe and are introduced into the vaporizer 10. In the case where two or more kinds of organic metal compounds or liquid silicon compounds are utilized, they may be introduced with providing three or more raw material pipes. Further, for washing the inside of the pipes, a pipe for a washing liquid may be provided. The mixed liquid is sprayed from an atomizer nozzle 17 and is instantaneously vaporized by the contact with a heated carrier gas. Moreover, a raw material gas pipe 18 is connected to a lower part of the vaporizer 10 for discharging the vaporized liquid raw material, that is raw material gas, from the vaporizer 10 and feeding the gas to a burner (oxyhydrogen flame burner) 16.

Incidentally, in addition to the raw material gas, oxygen gas and hydrogen gas for forming oxyhydrogen flame are fed to the burner 16. Moreover, although graphic representation is omitted, besides the first liquid raw material pipe 12, a carrier gas pipe for introducing the carrier gas is connected to the vaporizer 10 and furthermore, a mass flow controller for controlling a flow rate may be attached to the halfway position of each of the pipes. In FIG. 1, the numeral 19 indicates a carrier gas inlet for introducing the carrier gas into the vaporizer 10. Further, it is preferred to control the temperature of a tank for containing the liquid raw material and liquid raw material pipes to a temperature at which the liquid raw material exists in the form of a liquid. By the temperature control, for example, in such a case where the temperature of the room becomes low in winter, solidification of the raw material and decrease in solubility of the organic metal compound can be prevented from occurring.

### Raw Material Gas-Forming Step

In FIG. 1, for example, a part of the liquid silicon compound is introduced from the first liquid raw material pipe 12, and a liquid in which a sublimable organic metal compound has been dissolved or dispersed in the residual liquid silicon compound is introduced from the second liquid raw material pipe 14. These raw materials are mixed at the branching point of the first liquid raw material pipe 12 and both are transferred into the vaporizer 10 through the first liquid raw material pipe 12.

In this regard, at the time when the sublimable organic metal compound is dissolved or dispersed in the liquid silicon compound, the sublimable organic metal compound may be dissolved or dispersed in a solvent and then dissolved or dispersed in the liquid silicon compound.

Moreover, the total amount of the liquid silicon compound may be introduced from the first liquid raw material pipe 12 and a liquid obtained by dissolving or dispersing the sublimable organic metal compound in a solvent may be introduced from the second liquid raw material pipe 14.

Furthermore, depending on the situation, the total amount of the liquid raw materials containing the liquid silicon compound and the sublimable organic metal compound may be fed from both of the first and second liquid raw material pipes 12 and 14. In addition, it is also possible to feed them to the vaporizer 10 using only one of the first and second liquid raw material pipes 12 and 14. That is, for example, the second liquid raw material pipe 14 may not be provided. However, the concentration of the dopant can be easily regulated by the use of the first and second liquid raw material pipes 12 and 14, so that the second liquid raw material pipe 14 is preferably provided.

In the present invention, the liquid silicon compound and the sublimable organic metal compound are fed into the vaporizer 10 while the feeding amounts thereof are controlled by the mass flow controller attached to each of the first and second liquid raw material pipes 12 and 14. Since the liquid silicon compound and the sublimable organic metal compound are both fed to the vaporizer 10 through the first and second liquid raw material pipes 12 and 14 in their liquid states, the feeding amounts thereof can be well controlled by the mass flow controller. Namely, they can be fed to the vaporizer 10 at homogeneous flow rates.

In the present embodiment, the liquid raw materials are vaporized with introducing a carrier gas heated to 100° C. to 300° C. from the carrier gas inlet 19 at a flow rate of 1 L/minute to 20 L/minute. The heating temperature of the carrier gas is more preferably 150° C. or higher from the standpoint of vapor pressure of the organic metal compound and 250° C. or lower from the standpoint of thermal decomposition of the organic metal compound. As the carrier gas, use can be made of nitrogen gas, hydrogen gas, helium gas, argon gas, or the like. Of these, from the standpoint of preventing a decrease of the oxyhydrogen flame temperature, hydrogen gas is preferred. Moreover, the temperature in the vaporizer 10 is preferably set to 100° C. to 300° C. The set temperature is more preferably 150° C. or higher from the standpoint of securing the vapor pressure of the organic metal compound and 250° C. or lower from the standpoint of preventing the thermal decomposition of the organic metal compound.

### Glass Fine Particle-Forming Step and Base Material-Forming Step

Then, the raw material gas formed in the vaporizer 10 is fed to the burner 16 through the raw material gas pipe 18 together with the carrier gas. In the burner 16, hydrogen gas and oxygen gas are fed and oxyhydrogen flame is formed. The raw material gas fed is oxidized in the flame to form silica and a metal oxide, thereby forming silica fine particles containing the metal oxide. The formed silica fine particles are deposited on a target to form a porous glass base material.

### Densification Step

Thereafter, the obtained porous glass base material is baked at a high temperature, for example, at 1,000° C. to 1,300° C., and then, densified at 1,100° C. to 1,750° C. The densification temperature is preferably from 1,200° C. to 1,550° C., and more preferably 1,300° C. to 1,500° C. As an atmosphere, in the case of normal pressure, it is preferably an atmosphere of 100% inert gas such as helium or an atmosphere containing an inert gas such as helium as a main component. In the case of reduced pressure, the atmosphere is not particularly limited.

### Transparent Vitrification Step

The densified glass body is heated to a transparent vitrification temperature to obtain a transparent glass body. The transparent vitrification temperature is usually from 1,250° C. to 1,750° C. and is particularly preferably from 1,300° C. to 1,700° C. The atmosphere is preferably an atmosphere of 100% inert gas such as helium or argon or an atmosphere containing an inert gas such as helium as a main component. The pressure may be reduced pressure or normal pressure. Particularly, in the case of normal pressure, helium gas or argon gas can be used. In the case of reduced pressure, the pressure is preferably 13,000 Pa or lower. Thereby, a doped quartz glass can be obtained.

### Molding Step

The transparent glass body obtained in the transparent vitrification step is heated to a temperature of the softening point or higher and molded into a desired shape to obtain a molded glass body. The molding temperature is preferably from 1,500° C. to 1,800° C. In this regard, the transparent vitrification step and the molding step may be performed sequentially or simultaneously. Moreover, a two-step molding may be carried out, where the transparent glass body obtained in the transparent vitrification step is put in a mold and heated to a temperature of the softening point or higher and then the resulting molded body is put in another mold and heated to a temperature of the softening point or higher. Furthermore, in the case where it is not necessary to deform the shape of the transparent glass body obtained in the transparent vitrification step, the molding step may be omitted.

### Annealing Step

After the transparent glass body obtained in the transparent vitrification step or the molding step is held at a temperature of more than 500° C. and 1200° C. or lower for 2 hours or more, the glass body is subjected to an annealing treatment where the glass body is cooled to 500° C. or lower at an average cooling rate of 5° C./hr or less, whereby the fictive temperature of the glass is controlled. Alternatively, in the transparent vitrification step or the molding step, after a glass body is obtained, the glass body is subjected to an annealing treatment where the glass body is cooled to 500° C. or lower at an average cooling rate of 5° C./hr or less, whereby the fictive temperature of the doped quartz glass is controlled. After cooled to 500° C. or lower, the glass body can be allowed to stand to be cooled. The atmosphere in this step is preferably an atmosphere of 100% inert gas such as helium, argon, or nitrogen, an atmosphere containing any of these inert gases as a main component, or an air atmosphere and the pressure is preferably reduced pressure or normal pressure.

In order to achieve lower fictive temperature, it is effective to cool the glass body at a lower cooling rate in the temperature region in the vicinity of the annealing point or strain point of the glass. Specifically, in the cooling profile of the annealing step, the lowest cooling rate is preferably 1° C./hr or less, more preferably 0.5° C./hr or less, and particularly preferably 0.3° C./hr or less.

The fictive temperature of the doped quartz glass can be measured in a known manner. In Examples to be mentioned below, the fictive temperature of the doped quartz glass was measured in the following manner.

For a mirror-polished doped quartz glass, an absorption spectrum is obtained using an infrared spectroscope (Magna 760 manufactured by Nikolet Company being used in Examples to be mentioned below). On this occasion, a data interval is set about 0.5 cm⁻¹ and an average value obtained by scanning 64 times is used as the absorption spectrum. In the thus obtained infrared absorption spectrum, a peak observed in the vicinity of about 2,260 cm⁻¹ is attributed to a harmonic of stretching vibration by an Si—O—Si bond of the doped quartz glass. Using the peak position, a calibration curve is prepared with glasses whose fictive temperatures are known and which have the same composition, and the fictive temperature of the doped quartz glass is determined.

In the thus obtained doped quartz glass, since there is a small variation in the feeding amounts of the silicon compound and the sublimable organic metal compound as glass-forming materials into oxyhydrogen flame, the metal oxide is homogeneously distributed in the glass and thus the glass has high homogeneity. Moreover, since the feeding amounts of the silicon compound and the sublimable organic metal compound are easily controlled, the metal oxide can be contained at a desired concentration in the glass.

Incidentally, the doping amount of the metal element is preferably, in the case of Ce for example, in the range of 10 ppm to 50,000 ppm by weight and more preferably in the range of 100 ppm to 10,000 ppm by weight.

The present invention is not limited to the described contents of the embodiments explained in the above and is suitably changeable within the range not deviating from the gist of the present invention.

### EXAMPLES

The present invention is described in greater detail below by referring to Examples, but the present invention is not limited to these Examples.

### Example 1

As a sublimable organic metal compound, a β-diketone cerium complex (Ce(thd)₄) was used. The complex Ce(thd)₄ was dissolved in octamethylcyclotetrasiloxane (OMCTS) as a glass-forming raw material to prepare a liquid raw material (content of Ce(thd)₄: 0.20 wt %). After the liquid raw material was allowed to stand for 1 week, analyses by Fourier transformation infrared spectroscopy (FT-IR) and nuclear magnetic resonance (NMR) were carried out. Further, the liquid raw material was filtrated through a 0.45 μm filter and it was confirmed that no solid matter was attached onto the filter. Thus, it was confirmed that the decomposition of Ce(thd)₄ did not occur and the content of Ce(thd)₄ was not changed.

Using a vaporizer shown in FIG. 1, a carrier gas (hydrogen gas: a flow rate of 10 L/minute) heated to 200° C. and the above liquid raw material (a flow rate of 3 g/minute) were fed to the vaporizer set at 200° C., whereby the liquid raw material was vaporized in the vaporizer to form a raw material gas. The liquid raw material was fed through both of the first liquid raw material pipe 12 and the second liquid raw material pipe 14. The flow rate indicates the sum of the feeding amounts through the two pipes. The mixed gas of the carrier gas and the raw material gas was fed to a quartz-made concentric multi-tubular burner. The flow rate of the liquid raw material to the vaporizer was controlled by a liquid mass flow controller. Further, the temperature of the used liquid raw material tank and liquid raw material pipes were kept at 30° C.

Hydrogen gas (18 L/minute) and oxygen gas (18 L/minute) were fed to the quartz-made concentric multi-tubular burner to form oxyhydrogen flame and the above raw material gas (mixed gas) was fed from the center nozzle of the burner into the oxyhydrogen flame.

The raw material gas fed was oxidized by the oxyhydrogen flame to form fine particles, and the obtained fine particles were deposited on a target for 3 hours to obtain a porous glass base material having an outer diameter of 100 mm, a length of 150 mm, a weight of 300 g, and an average bulk density of 0.25 g/cm³.

Thereafter, the porous glass base material was thermally treated at 1,250° C., then densified at 1,510° C. under an He atmosphere, and subsequently heated to 1,680° C. under vacuum to obtain a transparent glass.

Then, the transparent glass body was held at 1,200° C. for 12 hours in an Ar atmosphere, cooled to 1,100° C. at 1.5° C./hour, then cooled to 1,080° C. at 1.0° C./hour, cooled to 1,044° C. at 0.5° C./hour, and cooled to 500° C. at 15° C./hour, followed by allowing to stand to be cooled.

The obtained transparent glass was evenly divided into three portions, i.e., one at early stage of synthesis, one at middle stage of synthesis, and one at final stage of synthesis in a growth axis direction, and the content of cerium oxide (CeO₂) in each portion was measured by fluorescent X-ray analysis. Using a CeO₂-doped SiO₂ glass for which the CeO₂ concentration had been measured by inductively coupled plasma (ICP) optical emission spectrometry, a calibration curve was prepared. With regard to the measurement accuracy, standard deviation was 5 ppm by weight when a sample of 500 ppm by weight was measured 5 times. The CeO₂ concentration was 520 ppm by weight, 525 ppm by weight, and 531 ppm by weight at the early stage of synthesis, at the middle stage of synthesis, and at the final stage of synthesis, respectively in that order. Thus, it was confirmed that the glass was a highly homogeneous quartz glass having a little difference in CeO₂ concentration.

The OH concentration of the obtained transparent glass was measured. The OH concentration of the doped quartz glass can be measured using a known method. For example, the OH concentration can be determined from an absorption peak at a wavelength of 2.7 μm upon the measurement with an infrared spectrophotometer (J. P. Williams et al., American Ceramic Society Bulletin, 55(5), 524, 1976). A detection limit by this method is 0.1 ppm. The OH concentration of the glass subjected to transparent vitrification was 22 ppm.

Upon the measurement of fictive temperature of the obtained transparent glass, it was 1,055° C.

### Example 2

A β-diketone cerium complex (Ce(thd)₄) was dissolved in tetrahydrofuran as an organic solvent to prepare a dopant raw material solution (content of Ce(thd)₄: 1 wt %). After the dopant raw material solution was allowed to stand for 1 week, analyses by Fourier transformation infrared spectroscopy (FT-IR) and nuclear magnetic resonance (NMR) were carried out. Further, the dopant raw material solution was filtrated through a 0.45 μm filter and it was confirmed that no solid matter was attached onto the filter. Thus, it was confirmed that the decomposition of Ce(thd)₄ did not occur and the content of Ce(thd)₄ was not changed.

Using a vaporizer shown in FIG. 1, the dopant raw material solution (a flow rate of 0.6 g/minute) from the first liquid raw material pipe 12, OMCTS (3 g/minute) as a glass-forming raw material from the second liquid raw material pipe 14, and further a carrier gas (hydrogen gas: a flow rate of 10 L/minute) heated to 200° C. were fed to the vaporizer set at 200° C., whereby the liquid raw materials, that is, the dopant raw material solution and OMCTS, were vaporized in the vaporizer to form a raw material gas. The mixed gas of the carrier gas and the raw material gas was fed to a quartz-made concentric multi-tubular burner. The flow rates of the dopant raw material solution and the glass-forming raw material to the vaporizer were each controlled by a liquid mass flow controller. Further, the temperature of the used liquid raw material tank and liquid raw material pipes were kept at 30° C.

Hydrogen gas (18 L/minute) and oxygen gas (18 L/minute) were fed to the quartz-made concentric multi-tubular burner to form oxyhydrogen flame and the above raw material gas (mized gas) was fed from the center nozzle of the burner into the oxyhydrogen flame.

The raw material gas fed was oxidized by the oxyhydrogen flame to form fine particles, and the obtained fine particles were deposited on a target for 3 hours to obtain a porous glass base material having an outer diameter of 100 mm, a length of 150 mm, a weight of 300 g, and an average bulk density of 0.25 g/cm³.

Thereafter, the porous glass base material was thermally treated at 1,250° C. and then heated to 1,600° C. under vacuum to obtain a transparent glass.

The obtained transparent glass was evenly divided into three portions in the same manner as in Example 1 and the content of cerium oxide (CeO₂) in each portion was measured by fluorescent X-ray analysis in the same manner as in Example 1. Upon the measurement, the CeO₂ concentration was 500 ppm by weight, 510 ppm by weight, and 506 ppm by weight at the early stage of synthesis, at the middle stage of synthesis, and at the final stage of synthesis, respectively in that order. Thus, it was confirmed that the glass is a highly homogeneous quartz glass having a little difference in CeO₂ concentration.

### Comparative Example

Using a vaporizer shown in FIG. 1, OMCTS (a flow rate of 3 g/minute) as a glass-forming raw material from the pipe 14 and a carrier gas (hydrogen gas: a flow rate of 5 L/minute) heated to 200° C. were fed to the vaporizer set at 200° C., whereby the raw material was vaporized in the vaporizer to form a raw material gas containing OMCTS. A powder of Ce(thd)₄ was introduced into a SUS-made evaporator having an inlet and an outlet of a carrier gas, and heated to 200° C., whereby Ce(thd)₄ as a dopant was sublimated. A carrier gas (hydrogen gas: a flow rate of 5 L/minute) heated to 200° C. was introduced into the evaporator, to thereby form a raw material gas containing Ce(thd)₄ (0.006 g/minuit). The raw material gas containing OMCTS and the raw material gas containing Ce(thd)₄ were mixed, and the mixed gas was fed to a quartz-made concentric multi-tubular burner. The flow rate of OMCTS to the vaporizer was controlled by a liquid mass flow controller. Further, the temperature of the used liquid raw material tank and liquid raw material pipes were kept at 30° C.

Hydrogen gas (18 L/minute) and oxygen gas (18 L/minute) were fed to the quartz-made concentric multi-tubular burner to form oxyhydrogen flame, and into the oxyhydrogen flame, from the center nozzle of the burner, the mixed gas of the raw material gases was fed.

The raw material gases fed were oxidized by the oxyhydrogen flame to form fine particles, and the obtained fine particles were deposited on a target for 3 hours to obtain a porous glass base material having an outer diameter of 100 mm, a length of 150 mm, a weight of 300 g, and an average bulk density of 0.25 g/cm³.

Thereafter, the porous glass base material was thermally treated at 1,250° C., then densified at 1,510° C. under an He atmosphere, and subsequently heated to 1,600° C. under vacuum to obtain a transparent glass.

The obtained transparent glass was evenly divided into three portions in the same manner as in Example 1 and the content of cerium oxide (CeO₂) in each portion was measured by fluorescent X-ray analysis in the same manner as in Example 1. Upon the measurement, the CeO₂ concentration was 520 ppm by weight, 481 ppm by weight, and 366 ppm by weight at the early stage of synthesis, at the middle stage of synthesis, and at the final stage of synthesis, respectively in that order. Thus, the glass is a heterogeneous quartz glass having a large variation in CeO₂ concentration.

In this regard, main causes of such a decrease in CeO₂ concentration as the elapsed time from the start of synthesis increases is considered to be a fact that the volume of the powder of β-diketone cerium complex (Ce(thd)₄) in the evaporator decreases as sublimation proceeds and thus the deviation from the saturated vapor pressure of the complex increases and a fact that the vapor pressure of the complex decreases as a result of decomposition of the complex by heating for a long period of time.

While the present invention has been described in detail with reference to the specific embodiments thereof, it will be apparent to one skilled in the art that various changes and modifications can be made therein without departing from the spirit and scope of the present invention.

The present application is based on the Japanese Patent Application No. 2012-025971 filed on Feb. 9, 2012 and the Japanese Patent Application No. 2013-020048 filed on Feb. 5, 2013, and the entire contents thereof are incorporated herein by reference. All references cited herein are incorporated in their entirety.

### INDUSTRIAL APPLICABILITY

The method for producing a doped quartz glass of the present invention can produce a quartz glass in which a metal element is homogeneously distributed at a desired concentration since a liquid raw material containing a silicon compound and a sublimable organic metal compound is vaporized and fed to oxyhydrogen flame. Therefore, the method is useful as a method for producing a doped quartz glass for use in applications such as an optical fiber laser, a light amplifier, an optical sensor, and an optical filter where such a high homogeneity is required.

What is claimed is:

1. A method for producing a doped quartz glass, comprising:
a raw material gas-forming step of vaporizing a liquid raw material containing a silicon compound and a sublimable organic metal compound to form a raw material gas and
a glass fine particle-forming step of feeding the raw material gas to oxyhydrogen flame and reacting the gas in the flame to form a glass fine particle.

2. The method for producing a doped quartz glass according to claim 1, further comprising:
a base material-forming step of depositing the glass fine particle on a substrate to form a porous glass base material, and
a vitrification step of sintering the porous glass base material to achieve transparent vitrification.

3. The method for producing a doped quartz glass according to claim 1, further comprising:
a vitrification step of depositing the glass fine particle on a substrate and melting the particle simultaneously with deposition to achieve vitrification.

4. The method for producing a doped quartz glass according to claim 1, wherein the silicon compound contains no halogen.

5. The method for producing a doped quartz glass according to claim 1, wherein the silicon compound is a liquid silicon compound that is in the form of a liquid at at least one temperature in a temperature range of from 10° C. to 150° C.

6. The method for producing a doped quartz glass according to claim 5, wherein the sublimable organic metal compound is contained in the liquid raw material in a state dissolved or dispersed in the liquid silicon compound or a mixture comprising the liquid silicon compound and a solvent.

7. The method for producing a doped quartz glass according to claim 5, wherein the liquid raw material is obtained by dissolving or dispersing the sublimable organic metal compound in at least a part of the liquid silicon compound and then optionally mixing the resulting solution or dispersion with the liquid silicon compound, or obtained by dissolving or dispersing the sublimable organic metal compound in a solvent and then mixing the resulting solution or dispersion with the liquid silicon compound.

8. The method for producing a doped quartz glass according to claim 6, wherein the solvent is at least one selected from the group consisting of ethers and hydrocarbons.

9. The method for producing a doped quartz glass according to claim 1, wherein the silicon compound is at least one selected from the group consisting of hexamethyldisiloxane, hexamethylcyclotrisiloxane, octamethylcyclotetrasiloxane, decamethylcyclopentasiloxane, methyltrimethoxysilane, methyltriethoxysilane, tetramethoxysilane, and tetraethoxysilane.

10. The method for producing a doped quartz glass according to claim 1, wherein the sublimable organic metal compound is a β-diketone complex.

11. The method for producing a doped quartz glass according to claim 1, wherein the sublimable organic metal compound is an organic rare earth element compound.

12. The method for producing a doped quartz glass according to claim 1, wherein the liquid raw material contains no halide.
